(19) United States
(12) Patent Application Publication
(10) Pub. No.: US 2026/0267311 A1
(43) Pub. Date: Sep. 10, 2026

(54) SYSTEM, ELECTRONIC DEVICE AND COMPUTER-READABLE STORAGE MEDIUM FOR COLLISION DETECTION OF FIVE-AXIS COMPUTER NUMERICAL CONTROL MACHINE TOOL

(71) Applicants: 38TH RESEARCH INSTITUTE, CHINA ELECTRONICS TECHNOLOGY GROUP CORPORATION, Hefei (CN); HUAZHONG UNIVERSITY OF SCIENCE AND TECHNOLOGY, Wuhan (CN)

(72) Inventors: Mei WANG, Hefei (CN); Shuyan GAO, Wuhan (CN); Tao HUANG, Wuhan (CN); Yuxiao PAN, Wuhan (CN); Wenqiang YAN, Hefei (CN); Xiaoming ZHANG, Wuhan (CN); Han DING, Wuhan (CN)

(21) Appl. No.: 19/555,874

(22) Filed: Mar. 3, 2026

Related U.S. Application Data
(63) Continuation of application No. PCT/CN2023/126419, filed on Oct. 25, 2023.

(30) Foreign Application Priority Data
Sep. 4, 2023 (CN) 202311134411.5

(51) Int. Cl. G05B 19/402

(52) U.S. Cl. CPC G05B 19/402; G05B 2219/49141

(57) ABSTRACT

A collision detection system for a five-axis CNC machine tool, an electronic device, and a storage medium are provided, which relate to the field of numerical control machine tools. The five-axis CNC machine tool collision detection system includes: a machine tool tree construction module, a coordinate system transformation module, a joint parameter calculation module, a motion simulation module, and a collision detection module. The system sets inner nodes and outer nodes according to a machine tool structure and obtains offsets; calculates homogeneous transformation matrices; reads a numerical control program and calculates joint parameters of the machine tool; performs motion simulation; and calculates absolute coordinates of surface points of links of two joints during the motion simulation to perform collision detection between two sets of meshes.

### CROSS-REFERENCE TO RELATED APPLICATIONS

This application is a continuation of International Patent Application No. PCT/CN2023/126419, filed on Oct. 25, 2023, which claims the benefit of priority from Chinese Patent Application No. 202311134411.5, filed on Sep. 4, 2023, and entitled “GENERAL METHOD AND SYSTEM FOR MOTION SIMULATION AND COLLISION DETECTION OF A FIVE-AXIS COMPUTER NUMERICAL CONTROL MACHINE TOOL.” The content of the aforementioned application is incorporated herein by reference in its entirety.

### TECHNICAL FIELD

The present disclosure relates to the technical field of computer numerical control (CNC) machine tools, and in particular, to a system, electronic device and computer-readable storage medium for collision detection of a five-axis CNC machine tool.

### BACKGROUND

With the rapid development of modern manufacturing toward high precision and high complexity, five-axis CNC machine tools, as core equipment in the field of high-end manufacturing, have been widely applied in key fields such as precision instruments, high-end medical devices, and cutting-edge scientific research. The machining precision and reliability of the five-axis CNC machine tools directly determine the manufacturing quality of high-end equipment.

During an actual machining process of the five-axis CNC machine tool, abnormal phenomena such as tool collision and component interference may easily cause irreversible damage to a machine tool body, tools, and workpieces, which not only increases production costs but also severely affects production efficiency. Therefore, motion simulation and collision detection based on a numerical control program have become indispensable key procedures prior to machining by the five-axis CNC machine tool. By constructing a virtual machining environment based on digital twin technology and performing full-process simulation on a machining process of the machine tool, pose accuracy and collision risks of various moving components under the control of the numerical control program can be detected in real time, thereby providing important support for implementing intelligent integration of machining by the five-axis CNC machine tool and ensuring machining safety.

At present, in the related art, methods for calculating absolute poses of various components of the five-axis CNC machine tool based on a numerical control program generally suffer from insufficient versatility. Such methods require strict distinction among five-axis machine tool types and require fixed preset relative distance parameters between axes. As a result, such methods cannot be adapted to different models and different structures of the five-axis CNC machine tools, thereby significantly limiting the widespread application of motion simulation and collision detection technologies for the five-axis CNC machine tools and making it difficult to satisfy diversified high-end manufacturing requirements.

### SUMMARY

In view of the deficiencies in the prior art, the present disclosure provides a collision detection system for a five-axis CNC machine tool, an electronic device, and a storage medium, thereby solving problems in which calculation of absolute poses of various components of the five-axis CNC machine tool has insufficient versatility, requires strict distinction among machine tool types and fixed preset relative distance parameters between axes, and cannot be adapted to different types of five-axis CNC machine tools.

In order to achieve the foregoing objectives, the present disclosure provides the following technical solutions.

In a first aspect, the present disclosure provides a collision detection system for a five-axis CNC machine tool, comprising:
a machine tool tree construction module, configured to set inner nodes and outer nodes according to a structure of the five-axis CNC machine tool to construct a machine tool tree, and to obtain offsets of the inner nodes and the outer nodes, wherein the outer nodes correspond to three-dimensional models of components of the five-axis CNC machine tool, and the inner nodes correspond to joints of the five-axis CNC machine tool;
a coordinate system transformation module, configured to calculate, according to the machine tool tree and the offsets, homogeneous transformation matrices of joint coordinate systems, three-dimensional model coordinate systems, a tool tip point coordinate system, and a workpiece coordinate system relative to a world coordinate system {O} when the five-axis CNC machine tool is at an initial position;
a joint parameter calculation module, configured to read a numerical control program and calculate joint parameters of the five-axis CNC machine tool according to the homogeneous transformation matrices;
a motion simulation module, configured to, starting from a root node of the machine tool tree and in an order from a parent node to a child node, sequentially calculate exponential products of the joints and homogeneous transformation matrices of the three-dimensional model coordinate systems relative to the world coordinate system {O} using a recursive computation method, and to set positions of the three-dimensional models to perform motion simulation; and
a collision detection module, configured to calculate absolute coordinates of surface points on links corresponding to two joints among the joints during the motion simulation, and to perform collision detection between two sets of meshes.

According to the first aspect of the present disclosure, the coordinate system transformation module configured to calculate, according to the machine tool tree and the offsets, the homogeneous transformation matrices of the joint coordinate systems, the three-dimensional model coordinate systems, the tool tip point coordinate system, and the workpiece coordinate system relative to the world coordinate system {O} when the five-axis CNC machine tool is at the initial position is configured to:
calculate, according to the machine tool tree and the offsets, homogeneous transformation matrices of the joint coordinate systems relative to the world coordinate system {O} when the five-axis CNC machine tool is at the initial position according to the following expression:

$$\{ \begin{matrix}{}_{}^{O} {T}_{1}^{} ( 0 ) = {I}_{4 \times 4} \\ {}_{}^{O} {T}_{i}^{} ( 0 ) = {}_{}^{O} {T}_{i - 1}^{} {( 0 )}^{i - 1} {T}_{i} ( i = 2 , … , n )\end{matrix} ,$$

wherein i denotes an i-th joint on a current kinematic chain, n denotes a total number of joints on the current kinematic chain, and a first joint is a machine bed joint, and ⁱ⁻¹Tᵢ denotes an offset of an i-th node; and
calculate, according to the machine tool tree and the offsets, homogeneous transformation matrices of the three-dimensional model coordinate systems, the tool tip point coordinate system {t}, and the workpiece coordinate system {w} relative to the world coordinate system {O} when the five-axis CNC machine tool is at the initial position according to the following expression:

$${}_{}^{O} {T}_{l}^{} ( 0 ) = {}_{}^{O} {T}_{j}^{} {( 0 )}^{j} {T}_{l} ,$$

wherein ^{O}Tⱼ denotes a homogeneous transformation matrix of a corresponding joint coordinate system relative to the world coordinate system {O}, and ^{j}Tₗ denotes an offset of a node or a homogeneous transformation matrix of the tool tip point coordinate system {t} or the workpiece coordinate system {w} relative to the corresponding joint coordinate system.

According to the first aspect of the present disclosure, the joint parameter calculation module configured to read the numerical control program and calculate the joint parameters of the five-axis CNC machine tool according to the homogeneous transformation matrices is configured to:
(S301) calculate revolute joint parameters according to the following expression:

$${}_{}^{w} {T}_{t}^{} {( {θ}_{1} , {θ}_{2} , {θ}_{3} , {θ}_{4} , {θ}_{5} )}_{, 3} = {}_{}^{O} {T}_{w}^{- 1} ( 0 ) {e}^{{m}_{1} {θ}_{1} [ {}^{O} {\overline{S}}_{1}^{} ]} {e}^{{m}_{2} {θ}_{2} [ {}^{O} {\overline{S}}_{2}^{} ]} {e}^{{m}_{3} {θ}_{3} [ {}^{O} {\overline{S}}_{3}^{} ]} {e}^{{m}_{4} {θ}_{4} [ {}^{O} {\overline{S}}_{4}^{} ]} {e}^{{m}_{5} {θ}_{5} [ {}^{O} {\overline{S}}_{5}^{} ]} {}_{}^{O} {T}_{t}^{} {( 0 )}_{, 3} ; \qquad ( 1 )$$

wherein θᵢ(i=1,2,3,4,5) denotes a joint parameter of an i-th joint on two kinematic chains consisting of a kinematic chain from the workpiece coordinate system {w} to a machine bed coordinate system {b} and a kinematic chain from the machine bed coordinate system {b} to the tool tip point coordinate system {t};
wherein ^{O}S̅ᵢ(i=1,2,3,4,5) denotes a motion twist under unit velocity in the world coordinate system {O} at an initial state;
wherein in a case where a corresponding joint is on a tool kinematic chain, mᵢ=1, and in a case where the corresponding joint is on a workpiece kinematic chain, mᵢ=−1;
wherein in a case where the corresponding joint is a revolute joint,

$${}^{O} {\overline{S}}_{i}^{} = [ \begin{matrix}{}^{O} {\overline{ω}}_{i}^{} \\ {}^{O} {\overline{p}}_{i}^{} \times {}^{O} {\overline{ω}}_{i}^{}\end{matrix} ] ,$$

and in a case where the corresponding joint is a prismatic joint,

$${}_{}^{O} {\overline{S}}_{i}^{} = [ \begin{matrix}{0}_{3 \times 1} \\ {}_{}^{O} {\overline{v}}_{i}^{}\end{matrix} ] , and {e}^{[ {}_{}^{O} {\overline{S}}_{i}^{} ] {m}_{i} {θ}_{i}} = [ \begin{matrix}{e}^{[ {}_{}^{O} {\overline{ω}}_{i}^{} ] {m}_{i} {θ}_{i}} & G ( {m}_{i} {θ}_{i} ) {}^{O} {\overline{v}}_{i} \\ 0 & 1\end{matrix} ] ,$$

wherein 0_{3×1} denotes a column vector consisting of three zeros, ^{O}v̅ᵢ and ^{O}ω̅ᵢ each denote a unit vector in a direction of joint motion, ^{O}p̅ᵢ denotes a vector from an origin of the world coordinate system {O} to an origin of an i-th joint coordinate system,

$${e}^{[ {}_{}^{O} {\overline{ω}}_{i}^{} ] {m}_{i} {θ}_{i}} = I + [ {}_{}^{O} {\overline{ω}}_{i}^{} ] sin ( {m}_{i} {θ}_{i} ) + {[ {}_{}^{O} {\overline{ω}}_{i}^{} ]}^{2} ( 1 - cos ( {m}_{i} {θ}_{i} ) ) , and$$

$$G ( {m}_{i} {θ}_{i} ) = {m}_{i} {θ}_{i} I + ( 1 - cos ( {m}_{i} {θ}_{i} ) ) [ {}_{}^{O} {\overline{ω}}_{i}^{} ] + {( {m}_{i} {θ}_{i} - sin ( {m}_{i} {θ}_{i} ) ) [ {}_{}^{O} {\overline{ω}}_{i}^{} ]}^{2} ;$$

wherein according to properties of homogeneous matrices and expression (1), the following expression is satisfied:

$${}_{}^{w} {R}_{t}^{} {( {θ}_{1} , {θ}_{2} , {θ}_{3} , {θ}_{4} , {θ}_{5} )}_{, 3} = {}_{}^{O} {R}_{w}^{- 1} ( 0 ) {e}^{{m}_{{R}_{1}} {θ}_{{R}_{1} [ {}_{}^{O} {\overline{ω}}_{{R}_{1}}^{} ]}} {e}^{{m}_{{R}_{2}} {θ}_{{R}_{2} [ {}_{}^{O} {\overline{ω}}_{{R}_{2}}^{} ]}} {}_{}^{O} {R}_{t}^{} {( 0 )}_{, 3} ,$$

wherein ^{O}R_{w}⁻¹(0) denotes an inverse of a rotation matrix of the workpiece coordinate system {w} relative to the world coordinate system {O} in a case where a joint parameter is zero, Rₜ(0)_{,3} denotes a rotation matrix of a tool coordinate system relative to the world coordinate system {O} in a case where the joint parameter is zero, and Rᵢ, i=1,2 denote an i-th revolute joint in the same order as described above;
wherein

$${e}^{- {m}_{{R}_{1}} {θ}_{{R}_{1} [ {}_{}^{O} {\overline{ω}}_{{R}_{1}}^{} ]}} a = {e}^{{m}_{{R}_{2}} {θ}_{{R}_{2} [ {}_{}^{O} {\overline{ω}}_{{R}_{2}}^{} ]}} b = c$$

is solved using Paden-Kahan subproblem 2, wherein a=^{O}R_{w}(0)^{w}Rₜ(θ₁,θ₂,θ₃,θ₄,θ₅)_{,3}, b=^{O}Rₜ(0)_{,3}, c=α^{O}ω̅_{R}_{₁}+β^{O}ω̅_{R}_{₂}+γ(^{O}ω̅_{R}_{₁}×^{O}ω̅_{R}_{₂}), and wherein

$$α = \frac{( {}_{}^{O} {\overline{ω}}_{{R}_{1}}^{T} {}_{}^{O} {\overline{ω}}_{{R}_{1}}^{} ) {}_{}^{O} {\overline{ω}}_{{R}_{2}}^{T} b - {}_{}^{O} {\overline{ω}}_{{R}_{1}}^{T} a}{{( {}_{}^{O} {\overline{ω}}_{{R}_{1}}^{T} {}_{}^{O} {\overline{ω}}_{{R}_{1}}^{} )}^{2} - 1}$$

$$β = \frac{( {}_{}^{O} {\overline{ω}}_{{R}_{1}}^{T} {}_{}^{O} {\overline{ω}}_{{R}_{1}}^{} ) {}_{}^{O} {\overline{ω}}_{{R}_{2}}^{T} a - {}_{}^{O} {\overline{ω}}_{{R}_{2}}^{T} b}{{( {}_{}^{O} {\overline{ω}}_{{R}_{1}}^{T} {}_{}^{O} {\overline{ω}}_{{R}_{2}}^{} )}^{2} - 1}$$

$$γ = \sqrt[\pm ]{\frac{{‖ a ‖}^{2} - {α}^{2} - {β}^{2} - 2 αβ {}_{}^{O} {\overline{ω}}_{{R}_{1}}^{T} {}_{}^{O} {\overline{ω}}_{{R}_{2}}^{}}{{‖ {}_{}^{O} {\overline{ω}}_{{R}_{1}}^{} \times {}_{}^{O} {\overline{ω}}_{{R}_{2}}^{} ‖}^{2}}} ; and$$

and the following solutions are obtained:

$${θ}_{{R}_{1}} = \frac{- atan 2 ( {}_{}^{O} {\overline{ω}}_{{R}_{1}}^{T} ( u \times v ) , {u}^{T} v )}{{m}_{{R}_{1}}} , wherein$$

$$u = a - {}_{}^{O} {\overline{ω}}_{{R}_{1}}^{} {}_{}^{O} {\overline{ω}}_{{R}_{1}}^{T} a , v = c - {}_{}^{O} {\overline{ω}}_{{R}_{1}}^{} {}_{}^{O} {\overline{ω}}_{{R}_{1}}^{T} c ;$$

$${θ}_{{R}_{2}} = \frac{atan 2 ( {}_{}^{O} {\overline{ω}}_{{R}_{2}}^{T} ( {u}^{′} \times {v}^{′} ) , {u}^{′ T} {v}^{′} )}{{m}_{{R}_{2}}} , wherein$$

$${u}^{′} = b - {}_{}^{O} {\overline{ω}}_{{R}_{2}}^{} {}_{}^{O} {\overline{ω}}_{{R}_{2}}^{T} b , {v}^{′} = c - {}_{}^{O} {\overline{ω}}_{{R}_{2}}^{} {}_{}^{O} {\overline{ω}}_{{R}_{2}}^{T} c ,$$

and wherein denotes ^{O}ω̅_{R}_{₁} unit vector in a motion direction of a first revolute joint, and ω̅ω̅_{R}_{₂} denotes a unit vector in a motion direction of a second revolute joint.

According to the first aspect of the present disclosure, the joint parameter calculation module configured to read the numerical control program and calculate the joint parameters of the five-axis CNC machine tool according to the homogeneous transformation matrices is further configured to:

(S302) calculate prismatic joint parameters according to the following expression:

$${}_{}^{O} {T}_{M}^{} {( 0 )}^{M} {{T}_{t} ( {θ}_{1} , {θ}_{2} , {θ}_{3} , {θ}_{4} , {θ}_{5} )}_{, 4} = {T}_{1} {e}^{{m}_{{P}_{1} {θ}_{{P}_{1}} [ {}^{O} {\overline{S}}_{{P}_{1}} ]}} {T}_{2} {e}^{{m}_{{P}_{2} {θ}_{{P}_{2}} [ {}^{O} {\overline{S}}_{{P}_{2}} ]}} {T}_{3} {e}^{{m}_{{P}_{3} {θ}_{{P}_{3}} [ {}^{O} {\overline{S}}_{{P}_{3}} ]}} {T}_{4} {}_{}^{O} {T}_{t}^{} {( 0 )}_{, 4} \qquad ( 4 )$$

wherein pᵢ, i=1,2,3 denotes an i-th prismatic joint in the same order as described above, T₁ denotes a product of homogeneous transformation matrices of revolute joints before p₁, T₂ denotes a product of homogeneous transformation matrices of revolute joints between p₁ and p₂, T₃ denotes a product of homogeneous transformation matrices of revolute joints between p₂ and p₃, and T₄ denotes a product of homogeneous transformation matrices of revolute joints after p₃;
wherein P′ denotes a displacement portion on a left-hand side of expression (2), and satisfies the following expression:

$${P}^{′} = {P}_{{T}_{1}} + {R}_{{T}_{1}} {P}_{{e}^{{m}_{{P}_{1}} {θ}_{{P}_{1} [ {}^{O} {\overline{S}}_{{P}_{1}} ]}}} + {R}_{{T}_{1}} {P}_{{T}_{2}} + {R}_{{T}_{1}} {R}_{{T}_{2}} {P}_{{e}^{{m}_{{P}_{2} {θ}_{{P}_{2}} [ {}^{O} {\overline{S}}_{{P}_{2}} ]}}} + {R}_{{T}_{1}} {R}_{{T}_{2}} {P}_{{T}_{3}} + {R}_{{T}_{1}} {R}_{{T}_{2}} {R}_{{T}_{3}} {P}_{{e}^{{m}_{{P}_{3} {θ}_{{P}_{3}} [ {}^{O} {\overline{S}}_{{P}_{3}} ]}}} + {R}_{{T}_{1}} {R}_{{T}_{2}} {R}_{{T}_{3}} {P}_{{T}_{4}} + {R}_{{T}_{1}} {R}_{{T}_{2}} {R}_{{T}_{3}} {P}_{{}^{O} {T}_{1} {( 0 )}_{, 4}} ,$$

which is simplified to obtain the following expression:

$$P = {R}_{{T}_{1}} {P}_{{e}^{{m}_{{P}_{1} {θ}_{{P}_{1}} [ {}^{O} {\overline{S}}_{{P}_{1}} ]}}} + {R}_{{T}_{1}} {R}_{{T}_{2}} {P}_{{e}^{{m}_{{P}_{2} {θ}_{{P}_{2}} [ {}^{O} {\overline{S}}_{{P}_{2}} ]}}} + {R}_{{T}_{1}} {R}_{{T}_{2}} {R}_{{T}_{3}} {P}_{{e}^{{m}_{{P}_{3} {θ}_{{P}_{3}} [ {}^{O} {\overline{S}}_{{P}_{3}} ]}}} ; \qquad ( 3 )$$

$$wherein P = {P}^{′} - {P}_{{T}_{`}} - {R}_{{T}_{1}} {P}_{{T}_{2}} - {R}_{{T}_{1}} {R}_{{T}_{2}} {P}_{{T}_{3}} - {R}_{{T}_{1}} {R}_{{T}_{2}} {R}_{{T}_{3}} {P}_{{T}_{4}} - {R}_{{T}_{1}} {R}_{{T}_{2}} {R}_{{T}_{3}} {R}_{{T}_{4}} {P}_{{}_{}^{O} {T}_{t}^{} {( 0 )}_{, 4}} ,$$

and according to expression (3), the following expression is obtained:

$$P = {R}_{x} {P}_{{e}^{{m}_{x} {θ}_{x} [ \overline{{}^{O} {S}_{x}} ]}} + {R}_{y} {P}_{{e}^{{m}_{y} {θ}_{y} [ \overline{{}^{O} {S}_{y}} ]}} + {R}_{z} {P}_{{e}^{{m}_{z} {θ}_{z} [ \overline{{}^{O} {S}_{z}} ]}} ,$$

wherein x denotes an X-axis prismatic joint, y denotes a Y-axis prismatic joint, and z denotes a Z-axis prismatic joint, and Rₓ,R_{y},R_{z} respectively denote corresponding SO(3) components in expression (3);
wherein

$$let P = R [ \begin{matrix}{θ}_{x} \\ {θ}_{y} \\ {θ}_{z}\end{matrix} ] = [ \begin{matrix}X \\ Y \\ Z\end{matrix} ] ,$$

$$R = [ {m}_{x} {R}_{x} {}_{}^{O} {v}_{x}^{} {m}_{y} {R}_{y} {}_{}^{O} {v}_{y}^{} {m}_{z} {R}_{z} {}_{}^{O} {v}_{z}^{} ] ,$$

and u=R_{1,1}R_{2,2}R_{3,3}−R_{3,2}R_{2,3}+R_{2,1}R_{3,2}R_{1,3}−R_{1,2} R_{3,3}+R_{3,1}R_{1,2}R_{2,3}−R_{2,2}R_{1,3};
the following solutions are obtained:

$$\{ \begin{matrix}{θ}_{x} = \frac{( {R}_{2 , 2} {R}_{3 , 3} - {R}_{3 , 2} {R}_{2 , 3} ) X + ( {R}_{3 , 2} {R}_{1 , 3} - {R}_{1 , 2} {R}_{3 , 3} ) Y + ( {R}_{1 , 2} {R}_{2 , 3} - {R}_{2 , 2} {R}_{1 , 3} ) Z}{{um}_{x}} \\ {θ}_{y} = \frac{( {R}_{3 , 1} {R}_{2 , 3} - {R}_{2 , 1} {R}_{3 , 3} ) X + ( {R}_{1 , 1} {R}_{3 , 3} - {R}_{3 , 1} {R}_{1 , 3} ) Y + ( {R}_{2 , 1} {R}_{1 , 3} - {R}_{1 , 1} {R}_{2 , 3} ) Z}{{um}_{y}} \\ {θ}_{z} = \frac{( {R}_{2 , 1} {R}_{3 , 2} - {R}_{3 , 1} {R}_{2 , 2} ) X + ( {R}_{3 , 1} {R}_{1 , 2} - {R}_{1 , 1} {R}_{3 , 2} ) Y + ( {R}_{1 , 1} {R}_{2 , 2} - {R}_{2 , 1} {R}_{1 , 2} ) Z}{{um}_{z}}\end{matrix} ,$$

thereby obtaining the prismatic joint parameters;
(S303) when a tool tip following function is turned off, joint parameters corresponding to a numerical control program Xx_{nc} Y y_{nc} Zz_{nc} Aa_{nc} Bb_{nc} Cc_{nc} are:

$${θ}_{x}^{′} = {m}_{x} {x}_{nc} + {θ}_{x} {θ}_{y}^{′} = {m}_{y} {y}_{nc} + {θ}_{y} , {θ}_{z}^{′} = {m}_{z} {z}_{nc} + {θ}_{z} , {θ}_{a}^{′} = {m}_{a} {a}_{nc} , {θ}_{b}^{′} = {m}_{b} {b}_{nc} , {θ}_{c}^{′} = {m}_{c} {c}_{nc} ;$$

wherein θₓ,θ_{y},θ_{z} are joint parameters, wherein

$${}_{}^{w} {T}_{t}^{} {( {θ}_{1} , {θ}_{2} , {θ}_{3} , {θ}_{4} , {θ}_{5} )}_{, 4} = [ \begin{matrix}0 \\ 0 \\ 0 \\ 1\end{matrix} ] ,$$

the revolute joint parameters are set to 0, and wherein mᵢ(i=x,y,z,a,b,c)=−1 in a case where the corresponding joint is on the workpiece kinematic chain and mᵢ(i=x,y,z,a,b,c)=1 in a case where the corresponding joint is on the tool kinematic chain; and
(S304) when the tool tip following function is turned on, joint parameters corresponding to the numerical control program Xx_{nc} Y y_{nc} Zz_{nc} Aa_{nc} Bb_{nc} Cc_{nc} are

$${θ}_{a}^{′} = {m}_{a} {a}_{n c} , {θ}_{b}^{′} = {m}_{b} {b}_{nc} , {θ}_{c}^{′} = {m}_{c} {c}_{n c} ;$$

$$wherein {θ}_{x}^{′} , {θ}_{y}^{′} , {θ}_{z}^{′}$$

are obtained by calculating

$${θ}_{a}^{′} , {θ}_{b}^{′} , {θ}_{c}^{′}$$

and then through step (S302), wherein at step (S302),

$${}_{}^{w} {T}_{t}^{} {( {θ}_{1} , {θ}_{2} , {θ}_{3} , {θ}_{4} , {θ}_{5} )}_{, 4} = [ \begin{matrix}{m}_{x} {x}_{nc} \\ {m}_{y} {x}_{nc} \\ {m}_{z} {x}_{nc} \\ 1\end{matrix} ] ,$$

and wherein mᵢ(i=x,y,z)=−1 in a case where a corresponding prismatic joint is on the workpiece kinematic chain and mᵢ(i=x,y,z)=1 in a case where the corresponding prismatic joint is on the tool kinematic chain.

According to the first aspect of the present disclosure, the motion simulation module configured to, starting from the root node of the machine tool tree and in the order from the parent node to the child node, sequentially calculate exponential products of the joints and the homogeneous transformation matrices of the three-dimensional model coordinate systems relative to the world coordinate system {O} using the recursive computation method, and to set the positions of the three-dimensional models to perform the motion simulation is configured to:
calculate an exponential product of each of joints on a workpiece kinematic chain and a tool kinematic chain according to the following expression:

$$\{ \begin{matrix}{T}_{1} = {I}_{4 \times 4} \\ {T}_{i} = {T}_{i - 1} {e}^{{θ}_{i} [ {}^{O} {\overline{S}}_{i} ] O} ( i = 2 , … , n )\end{matrix} ,$$

wherein i denotes an i-th joint on a current kinematic chain, n denotes a total number of joints on the current kinematic chain, and a first joint is a machine bed joint, and θᵢ denotes a joint parameter of an axis joint, wherein i=1,2,3,4,5, and for a non-axis joint, θᵢ=0; and
calculate a homogeneous transformation matrix of each three-dimensional model coordinate system of the three-dimensional model coordinate systems relative to the world coordinate system {O} according to the following expression:

$${}^{O} {T}_{m} = {T}^{O} {\overline{T}}_{m} ,$$

wherein T denotes an exponential product of a joint corresponding to the three-dimensional model that corresponds to the three-dimensional model coordinate system, and ^{O}T̅ₘ denotes a homogeneous transformation matrix of the three-dimensional model coordinate system relative to the world coordinate system {O} when the five-axis CNC machine tool is at the initial position.

According to the first aspect of the present disclosure, the collision detection module configured to calculate the absolute coordinates of the surface points on the links corresponding to the two joints among the joints during the motion simulation, and to perform the collision detection between the two sets of meshes is configured to:
determine that the three-dimensional models corresponding to all child nodes of a node of the machine tool tree that corresponds to a joint constitute links of the joint;
extract meshes of the three-dimensional models corresponding to all child nodes, and construct two bounding volume hierarchies of two links using a Morton Code method;
compare the two bounding volume hierarchies during collision detection, and when the two bounding volume hierarchies do not intersect, determine that two sets of triangle meshes do not intersect; and
when the two bounding volume hierarchies intersect, perform pairwise detection of intersections of child bounding volume hierarchies or sub-meshes until intersection testing of the triangle meshes is finally performed, and when the triangle meshes intersect, confirm that a collision occurs.

In a second aspect, the present disclosure provides a non-transitory computer-readable storage medium, wherein the non-transitory computer-readable storage medium stores a computer program that, when executed by a computer, causes the computer to perform functions corresponding to the machine tool tree construction module, the coordinate system transformation module, the joint parameter calculation module, the motion simulation module, and the collision detection module in the collision detection system provided in the first aspect.

In a third aspect, the present disclosure provides an electronic device, comprising:
one or more processors;
a memory; and
one or more programs stored in the memory and configured to be executed by the one or more processors, wherein the one or more programs comprise instructions that, when executed, cause the electronic device to perform functions corresponding to the machine tool tree construction module, the coordinate system transformation module, the joint parameter calculation module, the motion simulation module, and the collision detection module in the collision detection system provided in the first aspect.

Compared with the prior art, the collision detection system for the five-axis CNC machine tool, the electronic device, and the storage medium provided by the present disclosure have the following beneficial effects.

Through optimized design, the present disclosure enables a same five-axis CNC machine tool collision detection system to be adapted to perform motion simulation and collision detection for five-axis CNC machine tools having arbitrary structural types, thereby effectively avoiding disadvantages in the related art in which different numerical control programs are required for processing five-axis CNC machine tools having different structures and dedicated simulation software applicable only to specific models of five-axis CNC machine tools must be separately developed. Accordingly, versatility, adaptability, and processing efficiency of motion simulation and collision detection for five-axis CNC machine tools are significantly improved, development costs and barriers are reduced, and application requirements of diversified high-end manufacturing scenarios can be better satisfied.

### BRIEF DESCRIPTION OF THE DRAWINGS

In order to more clearly describe technical solutions in embodiments of the present disclosure or in the prior art, the accompanying drawings required for describing the embodiments or the prior art will be briefly introduced below. Apparently, the accompanying drawings described below merely illustrate some embodiments of the present disclosure, and those skilled in the art may further obtain other drawings according to the accompanying drawings without creative efforts.

FIG. 1 is a schematic structural diagram of a collision detection system for a five-axis CNC machine tool according to embodiments of the present disclosure.

FIG. 2 is a module interface diagram of TurboCut software for machine tool motion simulation and collision detection according to embodiments of the present disclosure.

FIG. 3 is a schematic structural diagram of a five-axis CNC machine tool according to embodiments of the present disclosure.

FIG. 4 is a test diagram of a five-axis CNC machine tool having a 45° B swing head and C rotary table.

FIG. 5 is a test diagram of a five-axis CNC machine tool having an AC swing head.

FIG. 6 is a test diagram of a five-axis CNC machine tool having a BC rotary table.

FIG. 7 is a test diagram of a five-axis CNC machine tool having a B swing head and C rotary table.

### DETAILED DESCRIPTION OF EMBODIMENTS

In order to make objectives, technical solutions, and advantages of embodiments of the present disclosure clearer, the technical solutions in the embodiments of the present disclosure are described clearly and completely below. Apparently, the described embodiments are merely some embodiments of the present disclosure rather than all embodiments thereof. All other embodiments obtained by those skilled in the art based on the embodiments of the present disclosure without creative efforts shall fall within the protection scope of the present disclosure.

By providing a collision detection system for a five-axis computer numerical control (CNC) machine tool, an electronic device, and a storage medium, the embodiments of the present disclosure solve problems in which calculation of absolute poses of various components of the five-axis CNC machine tool has insufficient versatility, requires strict distinction among machine tool types and fixed preset relative distance parameters between axes, and cannot be adapted to different types of five-axis CNC machine tools, thereby improving versatility and efficiency of motion simulation and collision detection for five-axis CNC machine tools.

In the embodiments of the present disclosure, a general technical concept for solving the above technical problems is as follows.

Motion simulation and collision detection technologies for CNC machine tools have been widely applied in high-precision machining scenarios for complex curved-surface parts. How to universally calculate absolute poses of various moving components of five-axis CNC machine tools having arbitrary configurations during a machining process and accurately identify potential interference and collision risks has become a core technical problem to be solved by both researchers and industrial manufacturers in this field.

A cutter location source file (CLSF) records a real-time relative pose of a tool tip point coordinate system relative to a workpiece coordinate system during a machining process. A numerical control (NC) program is generated from the CLSF through post-processing and is configured to drive coordinated motion of various axes of the machine tool. Conventional methods in the prior art for calculating absolute poses of various components of the machine tool based on the numerical control program require a specific configuration of the five-axis CNC machine tool to be distinguished in advance and must use fixed preset relative distance parameters between axes, thereby resulting in poor configuration adaptability and limited versatility and significantly reducing overall processing efficiency of motion simulation and collision detection for the five-axis CNC machine tool. To address the deficiencies of the prior art, the embodiments of the present disclosure provide the collision detection system for the five-axis CNC machine tool, the electronic device, and the storage medium, where a same numerical control program parsing and processing logic can be used to adapt to five-axis CNC machine tools having arbitrary structures without customizing differentiated processing schemes for machine tools having different configurations and without developing dedicated simulation software applicable only to a single model of machine tool, thereby significantly improving versatility, adaptability, and operational efficiency of motion simulation and collision detection for five-axis CNC machine tools.

In order to better understand the above technical solutions, the technical solutions are described in detail below with reference to the accompanying drawings and specific embodiments of the specification.

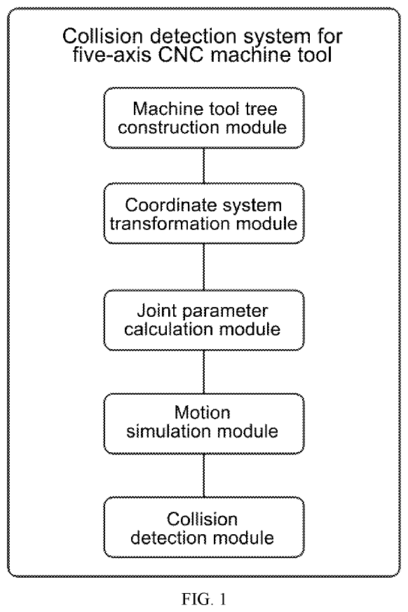

The embodiments of the present disclosure provide a collision detection system for a five-axis CNC machine tool. As shown in FIG. 1, the collision detection system includes a machine tool tree construction module, a coordinate system transformation module, a joint parameter calculation module, a motion simulation module, and a collision detection module.

The machine tool tree construction module is configured to set inner nodes and outer nodes according to a structure of the five-axis CNC machine tool to construct a machine tool tree, and to obtain offsets of the inner nodes and the outer nodes, where the outer nodes correspond to three-dimensional models of components of the five-axis CNC machine tool, and the inner nodes correspond to joints of the five-axis CNC machine tool.

The coordinate system transformation module is configured to calculate, according to the machine tool tree and the offsets, homogeneous transformation matrices of joint coordinate systems, three-dimensional model coordinate systems, a tool tip point coordinate system, and a workpiece coordinate system relative to a world coordinate system {O} when the five-axis CNC machine tool is at an initial position.

The joint parameter calculation module is configured to read a numerical control program and calculate joint parameters of the five-axis CNC machine tool according to the homogeneous transformation matrices.

The motion simulation module is configured to, starting from a root node of the machine tool tree and in an order from a parent node to a child node, sequentially calculate exponential products of the joints and homogeneous transformation matrices of the three-dimensional model coordinate systems relative to the world coordinate system {O} using a recursive computation method, and to set positions of the three-dimensional models to perform motion simulation.

The collision detection module is configured to calculate absolute coordinates of surface points on links corresponding to two joints among the joints during the motion simulation, and to perform collision detection between two sets of meshes.

The embodiments of the present disclosure can use a single system to perform motion simulation and collision detection for five-axis CNC machine tools having arbitrary structures. This avoids use of different numerical control program processing methods for five-axis CNC machine tools having different structures and avoids development of dedicated simulation software applicable only to a specific machine tool model, thereby effectively improving versatility and efficiency of motion simulation and collision detection for five-axis CNC machine tools.

In various embodiments of the present disclosure, each of the machine tool tree construction module, the coordinate system transformation module, the joint parameter calculation module, the motion simulation module, and the collision detection module may be implemented by one or more processors executing computer-readable instructions stored in a non-transitory computer-readable storage medium. The processors are configured to perform the respective functions through hardware-software integration, including the calculation of homogeneous transformation matrices, joint parameter solving using Paden-Kahan subproblems, recursive exponential product computations for motion simulation, and efficient bounding volume hierarchy (BVH)-based mesh intersection testing.

Furthermore, during the motion simulation process, the collision detection module continuously monitors the relative positions of the machine tool components. When a potential collision risk is identified between any two links (for example, between the tool and the workpiece, or between moving machine components), the system automatically issues an early warning to the operator. The warning may include visual alerts on the simulation interface, audible alarms, or detailed collision reports specifying the colliding components, their absolute coordinates, and the exact simulation timestamp. This proactive collision risk notification enables the operator to promptly adjust the numerical control program or machining parameters, thereby preventing physical damage to the five-axis CNC machine tool, reducing downtime, and enhancing overall machining safety and reliability.

The modules of the collision detection system for the five-axis CNC machine tool are described in detail below.

In the machine tool tree construction module, the inner nodes and the outer nodes are set according to the structure of the machine tool to construct the machine tool tree, and offsets of the inner nodes and the outer nodes are obtained, where the outer nodes correspond to three-dimensional models of components of the machine tool, and the inner nodes correspond to joints of the machine tool. A specific implementation is described below.

The machine tool tree includes the inner nodes and the outer nodes. The outer nodes of the machine tool tree correspond to the three-dimensional models, and the inner nodes correspond to the joints. When one inner node is a parent node of one outer node, it indicates that a three-dimensional model corresponding to the outer node is part of a link of a joint corresponding to the inner node. When one inner node is a parent node of another inner node, it indicates that, in a motion chain starting from a machine bed joint, a joint corresponding to the first inner node precedes a joint corresponding to the second inner node.

Setting an offset of a node refers to defining a homogeneous transformation matrix of a joint or a three-dimensional model coordinate system corresponding to the current node relative to a joint coordinate system corresponding to a parent node.

Before the offsets of the nodes are set, all coordinate systems coincide with the world coordinate system {O}. After the offsets are set, the positions of the joint axes enable the corresponding joints to move correctly.

The coordinate system transformation module is configured to calculate, according to the machine tool tree and the offsets, the homogeneous transformation matrices of the joint coordinate systems, the three-dimensional model coordinate systems, the tool tip point coordinate system, and the workpiece coordinate system relative to the world coordinate system {O} when the five-axis CNC machine tool is at the initial position as follows.

Homogeneous transformation matrices of the joint coordinate systems relative to the world coordinate system {O} when the five-axis CNC machine tool is at the initial position are calculated according to the following expression:

$$\{ \begin{matrix}{}^{O} {T}_{1} ( 0 ) = {I}_{4 \times 4} \\ {}^{O} {T}_{i} ( 0 ) = {}^{O} {T}_{i - 1} {( 0 )}^{i - 1} {T}_{i} ( i = 2 , … , n )\end{matrix} ,$$

where i denotes an i-th joint on a current kinematic chain, n denotes a total number of joints on the current kinematic chain, and a first joint is a machine bed joint, and ⁱ⁻¹Tᵢ
denotes an offset of an i-th node.

Homogeneous transformation matrices of the three-dimensional model coordinate systems, the tool tip point coordinate system {t}, and the workpiece coordinate system {w} relative to the world coordinate system {O} when the five-axis CNC machine tool is at the initial position are calculated according to the following expression:

$${}^{O} {T}_{l} ( 0 ) = {}^{O} {T}_{j} {( 0 )}^{j} {T}_{l} ,$$

where ^{O}Tⱼ denotes a homogeneous transformation matrix of a corresponding joint coordinate system relative to the world coordinate system {O}, and ^{j}Tₗ denotes an offset of a node or a homogeneous transformation matrix of the tool tip point coordinate system {t} or the workpiece coordinate system {w} relative to the corresponding joint coordinate system.

The joint parameter calculation module is configured to read the numerical control program and calculate the joint parameters of the five-axis CNC machine tool according to the homogeneous transformation matrices as follows.

S301: Revolute joint parameters are calculated according to the following expression:

$${}^{w} {T}_{t} {( {θ}_{1} , {θ}_{2} , {θ}_{3} , {θ}_{4} , {θ}_{5} )}_{, 3} = {}^{O} {T}_{w}^{- 1} ( 0 ) {e}^{{m}_{1} {θ}_{1} {[}^{O} {\overline{S}}_{1} ]} {e}^{{m}_{2} {θ}_{2} {[}^{O} {\overline{S}}_{2} ]} {e}^{{m}_{3} {θ}_{3} {[}^{O} {\overline{S}}_{3} ]} {e}^{{m}_{4} {θ}_{4} {[}^{O} {\overline{S}}_{4} ]} {e}^{{m}_{5} {θ}_{5} {[}^{O} \overline{{S}_{5}} ] O} {{T}_{t} ( 0 )}_{, 3} ; \qquad ( 1 )$$

where θᵢ(i=1,2,3,4,5) denotes a joint parameter of an i-th joint on two kinematic chains consisting of a kinematic chain from the workpiece coordinate system {w} to a machine bed coordinate system {b} and a kinematic chain from the machine bed coordinate system {b} to the tool tip point coordinate system {t};
where ^{O}S̅ᵢ(i=1,2,3,4,5) denotes a motion twist under unit velocity in the world coordinate system {O} at an initial state;
where in a case where a corresponding joint is on a tool kinematic chain, mᵢ=1, and in a case where the corresponding joint is on a workpiece kinematic chain, mᵢ=−1;
where in a case where the corresponding joint is a revolute joint,

$${}^{O} {\overline{S}}_{i} = [ \begin{matrix}{}^{O} {\overline{ω}}_{i} \\ {}^{O} {\overline{p}}_{i} \times {}^{O} {\overline{ω}}_{i}\end{matrix} ] ,$$

and in a case where the corresponding joint is a prismatic joint,

$${}^{O} \overline{{S}_{i}} = [ \begin{matrix}{0}_{3 \times 1} \\ {}^{O} {\overline{v}}_{i}\end{matrix} ] , and {e}^{[ {}^{O} {\overline{S}}_{i} ] {m}_{i} {θ}_{i}} = [ \begin{matrix}{e}^{[ {}^{O} {\overline{ω}}_{i} ] {m}_{i} {θ}_{i}} & G ( {m}_{i} {θ}_{i} ) {}^{O} {\overline{v}}_{i} \\ 0 & 1\end{matrix} ] ,$$

where 0_{3×1} denotes a column vector consisting of three zeros, ^{O}v̅ᵢ and ^{O}ω̅ᵢ each denote a unit vector in a direction of joint motion, ^{O}p̅ᵢ denotes a vector from an origin of the world coordinate system {O} to an origin of an i-th joint coordinate system,

$${e}^{{[}^{O} {\overline{ω}}_{i} ] {m}_{i} {θ}_{i}} = I + [ {}^{O} {\overline{ω}}_{i} ] sin ( {m}_{i} {θ}_{i} ) + {[ {}^{O} {\overline{ω}}_{i} ]}^{2} ( 1 - cos ( {m}_{i} {θ}_{i} ) ) , and$$

$$G ( {m}_{i} {θ}_{i} ) = {m}_{i} {θ}_{i} I + ( 1 - cos ( {m}_{i} {θ}_{i} ) ) [ {}^{O} {\overline{ω}}_{i} ] + {( {m}_{i} {θ}_{i} - sin ( {m}_{i} {θ}_{i} ) ) [ {}^{O} {\overline{ω}}_{i} ]}^{2} ;$$

where according to properties of homogeneous matrices and expression (1), the following expression is satisfied:

$${}^{w} {R}_{t} {( {θ}_{1} , {θ}_{2} , {θ}_{3} , {θ}_{4} , {θ}_{5} )}_{3} = {}^{O} {R}_{w}^{- 1} ( 0 ) {e}^{{m}_{{R}_{1}} {θ}_{{R}_{1}} {[}^{o} {\overline{ω}}_{{R}_{1}} ]} {e}^{{m}_{{R}_{2}} {θ}_{{R}_{2}} {[}^{o} {\overline{ω}}_{{R}_{2}} ] O} {{R}_{t} ( 0 )}_{, 3} ,$$

where ^{O}R_{w}⁻¹(0) denotes an inverse of a rotation matrix of the workpiece coordinate system {w} relative to the world coordinate system {O} in a case where a joint parameter is zero, Rₜ(0)_{,3} denotes a rotation matrix of a tool coordinate system relative to the world coordinate system {O} in a case where the joint parameter is zero, and Rᵢ, i=1,2 denote an i-th revolute joint in the same order as described above;
where

$${e}^{- {m}_{{R}_{1}} {θ}_{{R}_{1}} [ {}^{O} {\overline{ω}}_{{R}_{1}} ]} a = {e}^{{m}_{{R}_{2}} {θ}_{{R}_{2}} [ {}^{O} {\overline{ω}}_{{R}_{2}} ]} b = c$$

is solved using Paden-Kahan subproblem 2, wherein a=^{O}R_{W}(0)^{w}Rₜ(θ₁,θ₂,θ₃,θ₄,θ₅)_{,3}, b=^{O}Rₜ(0)_{,3}, c=α^{O}ω̅_{R}_{₁}+β^{O}ω̅_{R}_{₂}+γ(^{O}ω̅_{R}_{₁}×^{O}ω̅_{R}_{₂}), and where

$$α = \frac{{( {}^{O} {\overline{ω}}_{{R}_{\text{?}}}^{T} {}^{O} {\overline{ω}}_{{R}_{\text{?}}} )}^{O} {\overline{ω}}_{{R}_{\text{?}}}^{T} b - {}^{O} {\overline{ω}}_{{R}_{\text{?}}}^{T} a}{{( {}^{O} {\overline{ω}}_{{R}_{\text{?}}}^{T} {}^{O} {\overline{ω}}_{{R}_{\text{?}}} )}^{2} - 1}$$

$$β = \frac{( {}^{O} {\overline{ω}}_{{R}_{\text{?}}}^{T} {}^{O} {\overline{ω}}_{{R}_{\text{?}}} ) {}^{O} {\overline{ω}}_{{R}_{\text{?}}}^{T} a - {}^{O} {\overline{ω}}_{{R}_{\text{?}}}^{T} b}{{( {}^{O} {\overline{ω}}_{{R}_{\text{?}}}^{T} {}^{O} {\overline{ω}}_{{R}_{\text{?}}}^{T} )}^{2} - 1}$$

$$γ = \pm \sqrt{\frac{{‖ a ‖}^{2} - {α}^{2} - {β}^{2} - 2 αβ {}^{O} {\overline{ω}}_{{R}_{\text{?}}}^{T} {}^{O} {\overline{ω}}_{{R}_{\text{?}}}}{{‖ {}^{O} {\overline{ω}}_{{R}_{\text{?}}} \times {}^{O} {\overline{ω}}_{{R}_{\text{?}}} ‖}^{2}}} ;$$

$$\text{?} \text{indicates text missing or illegible when filed}$$

and
the following solutions are obtained:

$${θ}_{{R}_{1}} = \frac{- a tan 2 ( {}^{O} {\overline{ω}}_{{R}_{1}}^{T} ( u \times v ) , {u}^{T} v )}{{m}_{{R}_{1}}} , wherein$$

$$u = a - {}^{O} {\overline{ω}}_{{R}_{\text{?}}} {}^{O} {\overline{ω}}_{{R}_{\text{?}}}^{T} a , v = c - {}^{O} {\overline{ω}}_{{R}_{1}} {}^{O} {\overline{ω}}_{{R}_{1}}^{T} c ;$$

$${θ}_{{R}_{2}} = \frac{a tan 2 ( {}^{O} {\overline{ω}}_{{R}_{2}}^{T} ( {u}^{′} \times {v}^{′} ) , {u}^{′ T} {v}^{′} )}{{m}_{{R}_{2}}} , wherein$$

$${u}^{′} = b - {}^{O} {\overline{ω}}_{{R}_{2}} {}^{O} {\overline{ω}}_{{R}_{2}}^{T} b , {v}^{′} = c = {}^{O} {\overline{ω}}_{{R}_{2}} {}^{O} {\overline{ω}}_{{R}_{2}}^{T} c ,$$

$$\text{?} \text{indicates text missing or illegible when filed}$$

and where ^{O}ω̅_{R}_{₁} denotes a unit vector in a motion direction of a first revolute joint, and ^{O}ω̅_{R}_{₂} denotes a unit vector in a motion direction of a second revolute joint.

Since there are two possible values for γ, there are two sets of solutions for both θ_{R}_{₁} and θ_{R}_{₂}. However, during the simulation process, it is only necessary to calculate θ_{R}_{₁} and θ_{R}_{₂} when the numerical control program is X0Y0Z0A0B0C0. In general, the solutions for θ_{R}_{₁} and θ_{R}_{₂} are both 0 at this point. Therefore, either set of solutions can be selected.

S302: Prismatic joint parameters are calculated according to the following expression:

$${}^{O} {T}_{M} {( 0 )}^{M} {{T}_{t} ( {θ}_{1} , {θ}_{2} , {θ}_{3} , {θ}_{4} , {θ}_{5} )}_{, 4} = {T}_{1} {e}^{{m}_{{P}_{1}} {θ}_{{P}_{1}} [ {}^{O} {\overline{S}}_{{P}_{1}} ]} {T}_{2} {e}^{{m}_{{P}_{2}} {θ}_{{P}_{2}} [ {}^{O} {\overline{S}}_{{P}_{2}} ]} {T}_{3} {e}^{{m}_{{P}_{3}} {θ}_{{P}_{3}} [ {}^{O} {\overline{S}}_{{P}_{3}} ]} {T}_{4} {}^{O} {T}_{t} {( 0 )}_{, 4} \qquad ( 2 )$$

where pᵢ, i=1,2,3 denotes an i-th prismatic joint in the same order as described above, T₁ denotes a product of homogeneous transformation matrices of revolute joints before p₁, T₂ denotes a product of homogeneous transformation matrices of revolute joints between p₁ and p₂, T₃ denotes a product of homogeneous transformation matrices of revolute joints between p₂ and p₃, and T₄ denotes a product of homogeneous transformation matrices of revolute joints after p₃;
where P′ denotes a displacement portion on a left-hand side of expression (2), and satisfies the following expression:

$${P}^{′} = {P}_{{T}_{\text{?}}} + {R}_{{T}_{\text{?}}} {P}_{\text{?}} + {R}_{{T}_{\text{?}}} {{P}_{T}}_{\text{?}} + {R}_{{T}_{\text{?}}} {R}_{{T}_{\text{?}}} {P}_{\text{?}} + {R}_{{T}_{\text{?}}} {R}_{{T}_{\text{?}}} {R}_{{T}_{\text{?}}} {P}_{\text{?}} + {R}_{{T}_{\text{?}}} {R}_{{T}_{\text{?}}} {R}_{{T}_{\text{?}}} {P}_{\text{?}} + {R}_{{T}_{\text{?}}} {R}_{{T}_{\text{?}}} {R}_{{T}_{\text{?}}} {R}_{{T}_{\text{?}}} {P}_{\text{?}} ,$$

$$\text{?} \text{indicates text missing or illegible when filed}$$

which is simplified to obtain the following expression:

$$P = {{R}_{T}}_{1} {P}_{{e}^{{m}_{{P}_{1}} {θ}_{{P}_{1}} [ {}^{O} {\overline{S}}_{{P}_{1}} ]}} + {{R}_{T}}_{1} {{R}_{T}}_{2} {P}_{{e}^{{m}_{{P}_{2}} {θ}_{{P}_{2}} [ {}^{O} {\overline{S}}_{{P}_{2}} ]}} + {{R}_{T}}_{1} {{R}_{T}}_{2} {{R}_{T}}_{3} {P}_{{e}^{{m}_{{P}_{3}} {θ}_{{P}_{3}} [ {}^{O} {\overline{S}}_{{P}_{3}} ]}} ; \qquad ( 3 )$$

$$where P = {P}^{′} - {P}_{{T}_{1}} - {R}_{{T}_{1}} {P}_{{T}_{2}} - {R}_{{T}_{1}} {R}_{{T}_{2}} {P}_{{T}_{3}} - {R}_{{T}_{1}} {R}_{{T}_{2}} {R}_{{T}_{3}} {P}_{{T}_{4}} - {R}_{{T}_{1}} {R}_{{T}_{2}} {R}_{{T}_{3}} {R}_{{T}_{4}} {P}_{{}^{O} {T}_{t} {( 0 )}_{, 4}} ,$$

and according to expression (3), the following expression is obtained:

$$P = {R}_{x} {P}_{{e}^{{m}_{x} {θ}_{x} [ \overline{{O}^{} {S}_{x}} ]}} + {R}_{y} {P}_{{e}^{{m}_{y} {θ}_{y} [ \overline{{O}^{} {S}_{y}} ]}} + {R}_{Z} {P}_{{e}^{{m}_{z} {θ}_{z} [ \overline{{O}^{} {S}_{z}} ]}} ,$$

where x denotes an X-axis prismatic joint, y denotes a Y-axis prismatic joint, and z denotes a Z-axis prismatic joint, and Rₓ,R_{y},R_{z} respectively denote corresponding SO(3) components in expression (3);
where let

$$P = R [ \begin{matrix}{θ}_{x} \\ {θ}_{y} \\ {θ}_{z}\end{matrix} ] = [ \begin{matrix}X \\ Y \\ Z\end{matrix} ] , R = [ {m}_{x} {R}_{x} {}^{O} {v}_{x} {m}_{x} {R}_{y} {}^{O} {v}_{y} {m}_{z} {R}_{z} {}^{O} {v}_{z} ] ,$$

and u=R_{1,1}R_{2,2} R_{3,3}−R_{3,2}R_{2,3}+R_{2,1}R_{3,2}R_{1,3}−R_{1,2} R_{3,3}+R_{3,1}R_{1,2}R_{2,3}−R_{2,2}R_{1,3};
the following solutions are obtained:

$$\{ \begin{matrix}{θ}_{x} = \frac{\begin{matrix}( {R}_{2 , 2} {R}_{3 , 3} - {R}_{3 , 2} {R}_{2 , 3} ) X + ( {R}_{3 , 2} {R}_{1 , 3} - \\ {R}_{1 , 2} {R}_{3 , 3} ) Y + ( {R}_{1 , 2} {R}_{2 , 3} - {R}_{2 , 2} {R}_{1 , 3} ) Z\end{matrix}}{u {m}_{x}} \\ {θ}_{y} = \frac{\begin{matrix}( {R}_{3 , 1} {R}_{2 , 3} - {R}_{2 , 1} {R}_{3 , 3} ) X + ( {R}_{1 , 1} {R}_{3 , 3} - \\ {R}_{3 , 1} {R}_{1 , 3} ) Y + ( {R}_{2 , 1} {R}_{1 , 3} - {R}_{1 , 1} {R}_{2 , 3} ) Z\end{matrix}}{u {m}_{y}} , \\ {θ}_{z} = \frac{\begin{matrix}( {R}_{2 , 1} {R}_{3 , 2} - {R}_{3 , 1} {R}_{2 , 2} ) X + ( {R}_{3 , 1} {R}_{1 , 2} - \\ {R}_{1 , 1} {R}_{3 , 2} ) Y + ( {R}_{1 , 1} {R}_{2 , 2} - {R}_{2 , 1} {R}_{1 , 2} ) Z\end{matrix}}{u {m}_{z}}\end{matrix}$$

thereby obtaining the prismatic joint parameters.

S303: When a tool tip following function is turned off, joint parameters corresponding to a numerical control program Xx_{nc} Y y_{nc} Zz_{nc} Aa_{nc} Bb_{nc} Cc_{nc} are:

$${θ}_{x}^{′} = {m}_{x} {x}_{n c} + {θ}_{x} , {θ}_{y}^{′} = {m}_{y} {y}_{n c} + {θ}_{y} , {θ}_{z}^{′} = {m}_{z} {z}_{n c} + {θ}_{z} ,$$

$${θ}_{a}^{′} = {m}_{a} {a}_{n c} , {θ}_{b}^{′} = {m}_{b} {b}_{n c} , {θ}_{c}^{′} = {m}_{c} {c}_{n c} ;$$

where θₓ,θ_{y},θ_{z} are joint parameters, wherein

$${}^{w} {T}_{t} {( {θ}_{1} , {θ}_{2} , {θ}_{3} , {θ}_{4} , {θ}_{5} )}_{, 4} = [ \begin{matrix}0 \\ 0 \\ 0 \\ 1\end{matrix} ] ,$$

the revolute joint parameters are set to 0, and wherein mᵢ(i=x,y,z,a,b,c)=−1 in a case where the corresponding joint is on the workpiece kinematic chain and mᵢ(i=x,y,z,a,b,c)=1 in a case where the corresponding joint is on the tool kinematic chain.

S304: When the tool tip following function is turned on, joint parameters corresponding to the numerical control program Xx_{nc} Y y_{nc} Zz_{nc} Aa_{nc} Bb_{nc} Cc_{nc} are

$${θ}_{a}^{′} = {m}_{a} {a}_{n c} , {θ}_{b}^{′} = {m}_{b} {b}_{nc} , {θ}_{c}^{′} = {m}_{c} {c}_{n c} ;$$

$$where {θ}_{x}^{′} , {θ}_{y}^{′} , {θ}_{z}^{′}$$

are obtained by calculating

$${θ}_{a}^{′} , {θ}_{b}^{′} , {θ}_{c}^{′}$$

and then through step (S302), where at step (S302),

$${}^{w} {T}_{t} {( {θ}_{1} , {θ}_{2} , {θ}_{3} , {θ}_{4} , {θ}_{5} )}_{, 4} = [ \begin{matrix}{m}_{x} {x}_{n c} \\ {m}_{y} {y}_{n c} \\ {m}_{z} {z}_{n c} \\ 1\end{matrix} ] ,$$

and where mᵢ(i=x,y,z)=−1 in a case where a corresponding prismatic joint is on the workpiece kinematic chain and mᵢ(i=x,y,z)=1 in a case where the corresponding prismatic joint is on the tool kinematic chain.

The motion simulation module configured to, starting from the root node of the machine tool tree and in the order from the parent node to the child node, sequentially calculate exponential products of the joints and the homogeneous transformation matrices of the three-dimensional model coordinate systems relative to the world coordinate system {O} using the recursive computation method, and to set the positions of the three-dimensional models to perform the motion simulation as follows.

An exponential product of each of joints on a workpiece kinematic chain and a tool kinematic chain is calculated according to the following expression:

$$\{ \begin{matrix}{T}_{1} = {I}_{4 \times 4} \\ {T}_{i} = {T}_{i - 1} {e}^{{θ}_{i} {[}^{O} \overline{{S}_{i}} ] O} ( i = 2 , … , n )\end{matrix} ,$$

where i denotes an i-th joint on a current kinematic chain, n denotes a total number of joints on the current kinematic chain, and a first joint is a machine bed joint, and θᵢ denotes a joint parameter of an axis joint, where i=1,2,3,4,5. For a non-axis joint (such as a joint corresponding to a “spindle” node and a joint corresponding to a “fixture” node), θᵢ=0.

A homogeneous transformation matrix of each three-dimensional model coordinate system of the three-dimensional model coordinate systems relative to the world coordinate system {O} is calculated according to the following expression:

$${}^{O} {T}_{m} = {T}^{O} {\overline{T}}_{m} ,$$

where T denotes an exponential product of a joint corresponding to the three-dimensional model that corresponds to the three-dimensional model coordinate system, and ^{O}T̅ₘ denotes a homogeneous transformation matrix of the three-dimensional model coordinate system relative to the world coordinate system {O} when the five-axis CNC machine tool is at the initial position.

The collision detection module is configured to calculate the absolute coordinates of the surface points on the links corresponding to the two joints among the joints during the motion simulation, to perform the collision detection between the two sets of meshes, and to accelerate collision detection using a bounding volume hierarchy (BVH) method as follows.

The three-dimensional models corresponding to all child nodes of a joint node of the machine tool tree constitute links of the joint. Meshes of the three-dimensional models corresponding to all child nodes are extracted, and two bounding volume hierarchies of two links are constructed using a Morton Code method. The two bounding volume hierarchies are compared during collision detection. When the two bounding volume hierarchies do not intersect, it is determined that two sets of triangle meshes do not intersect. When the two bounding volume hierarchies intersect, pairwise detection of intersections of child bounding volume hierarchies or sub-meshes is performed until intersection testing of the triangle meshes is finally performed. When the triangle meshes intersect, a collision is determined to have occurred.

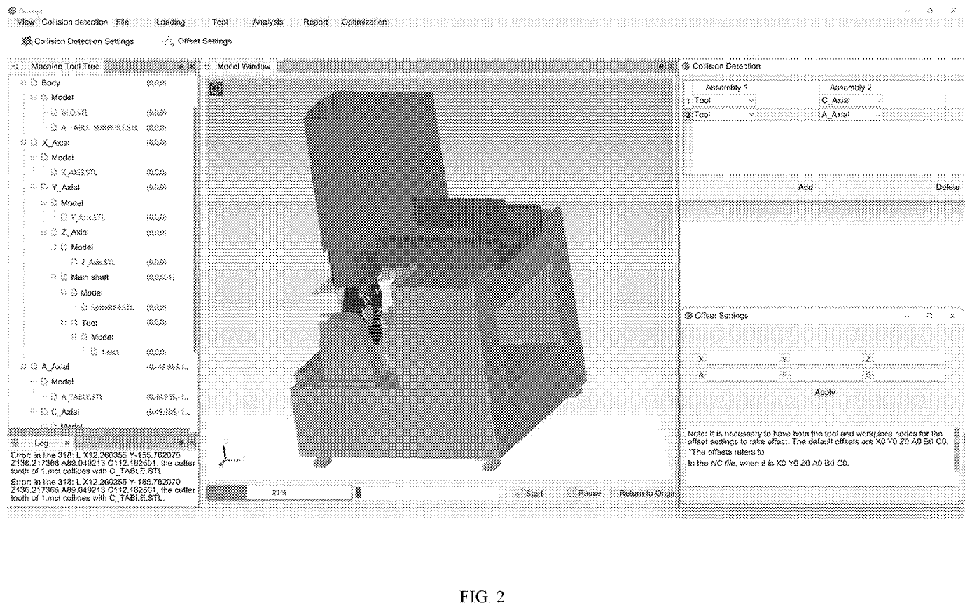

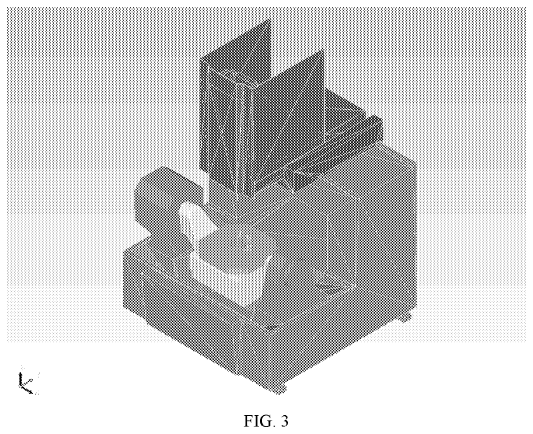

In one implementation process, software implementing the functions of the modules of the collision detection system is developed as executable code. Motion simulation and collision detection of a Mikron UCP 800 Duro five-axis CNC machine tool are illustrated below using TurboCut software, as shown in FIGS. 2-3.

S1: A machine tool tree is constructed, tree nodes are set according to a machine tool structure, and offsets of the tree nodes are set according to the kinematic structure of the machine tool. An offset of an “A-axis” node is set to (0, −49.985, 120.024, 0, 0, 0), an offset of a “C-axis” node is set to (0, 49.985, −120.024, 0, 0, 0), an offset of a “spindle” node is set to (0, 0, 601, 0, 0, 0), an offset of a “workpiece” node is set to (0, 0, 100, 0, 0, 0), and an offset of an “A_TABLE.STL” node is set to (0, 49.985, −120.024, 0, 0, 0).

S2: Homogeneous transformation matrices of the joint coordinate systems, the three-dimensional model coordinate systems, the tool tip point coordinate system {t}, and the workpiece coordinate system {w} relative to the world coordinate system {O} are calculated when the machine tool is at the initial position. The calculated homogeneous transformation matrices of the respective joint coordinate systems relative to the world coordinate system {O} when the machine tool is at the initial position are as follows.

For a machine bed, an X-axis, a Y-axis, a Z-axis, a C-axis, and a clamp joint: I_{4×4}.

For a spindle and a tool joint:

$$[ \begin{matrix}1 & 0 & 0 & 0 \\ 0 & 1 & 0 & 0 \\ 0 & 0 & 1 & 601 \\ 0 & 0 & 0 & 1\end{matrix} ] .$$

For a workpiece joint:

$$[ \begin{matrix}1 & 0 & 0 & 0 \\ 0 & 1 & 0 & 0 \\ 0 & 0 & 1 & 100 \\ 0 & 0 & 0 & 1\end{matrix} ] .$$

For an A-axis joint:

$$[ \begin{matrix}1 & 0 & 0 & 0 \\ 0 & 1 & 0 & ‐ 49.985 \\ 0 & 0 & 1 & 120. 024 \\ 0 & 0 & 0 & 1\end{matrix} ] .$$

The homogeneous transformation matrices of the respective model coordinate systems relative to the world coordinate system {O} are respectively as follows.

For BED.STL, A_TABLE_SURPORT.STL, X_AXIS.STL, Y_AXIS.STL, Z_AXIS.STL, A_TABLE.STL, and C_TABLE. STL models: I_{4×4}.

For a Spindle4.STL model:

$$[ \begin{matrix}1 & 0 & 0 & 0 \\ 0 & 1 & 0 & 0 \\ 0 & 0 & 1 & 601 \\ 0 & 0 & 0 & 1\end{matrix} ] .$$

For a stock.stl model:

$$[ \begin{matrix}1 & 0 & 0 & 0 \\ 0 & 1 & 0 & 0 \\ 0 & 0 & 1 & 100 \\ 0 & 0 & 0 & 1\end{matrix} ] .$$

The axis joint twists represented relative to the world coordinate system {O} are respectively as follows.

For the X-axis:

$${}^{O} \overline{{S}_{x}} = [ \begin{matrix}0 \\ 0 \\ 0 \\ 1 \\ 0 \\ 0\end{matrix} ] .$$

For the Y-axis:

$${}^{O} \overline{{S}_{y}} = [ \begin{matrix}0 \\ 0 \\ 0 \\ 0 \\ 1 \\ 0\end{matrix} ] .$$

For the Z-axis:

$${}^{O} \overline{{S}_{z}} = [ \begin{matrix}0 \\ 0 \\ 0 \\ 0 \\ 0 \\ 1\end{matrix} ] .$$

For the A-axis:

$${}^{O} \overline{{S}_{a}} = [ \begin{matrix}1 \\ 0 \\ 0 \\ 0 \\ 120.024 \\ 49.985\end{matrix} ] .$$

For the C-axis:

$${}^{O} \overline{{S}_{z}} = [ \begin{matrix}0 \\ 0 \\ 1 \\ 0 \\ 0 \\ 0\end{matrix} ] .$$

S3: A numerical control program is read and joint parameters of the axes are calculated.

S4: Starting from a root node and in an order from a parent node to a child node, exponential products of the joints and the homogeneous transformation matrices of the three-dimensional model coordinate systems relative to the world coordinate system {O} are sequentially calculated, and positions of virtual three-dimensional models corresponding to respective components in the machine tool are set to perform motion simulation.

S5: Three-dimensional models corresponding to all child nodes of a node of the machine tool tree that corresponds to a joint constitute links of the joint. Meshes of the three-dimensional models are extracted, and two bounding volume hierarchies of two links are efficiently constructed using a Morton Code method. During collision detection, the two bounding volume hierarchies are compared. When the two bounding volume hierarchies do not intersect, the two sets of triangle meshes do not intersect. When the two bounding volume hierarchies intersect, pairwise detection of intersections of child bounding volume hierarchies or sub-meshes is performed until intersection testing of the triangle meshes is finally performed. When the triangle meshes intersect, a collision is determined to have occurred.

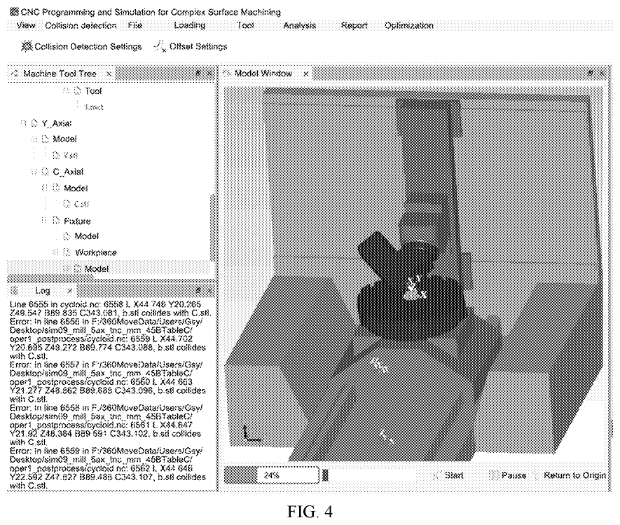

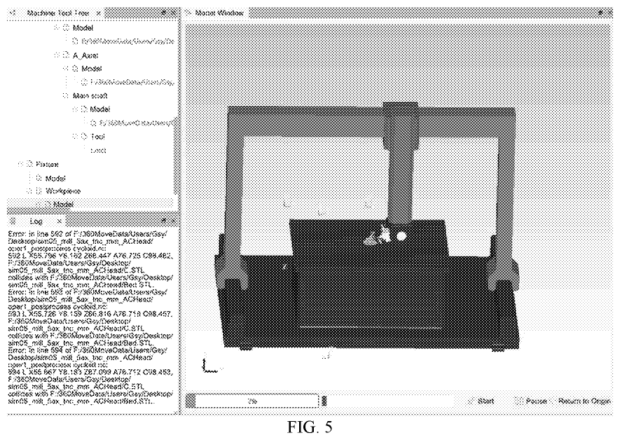

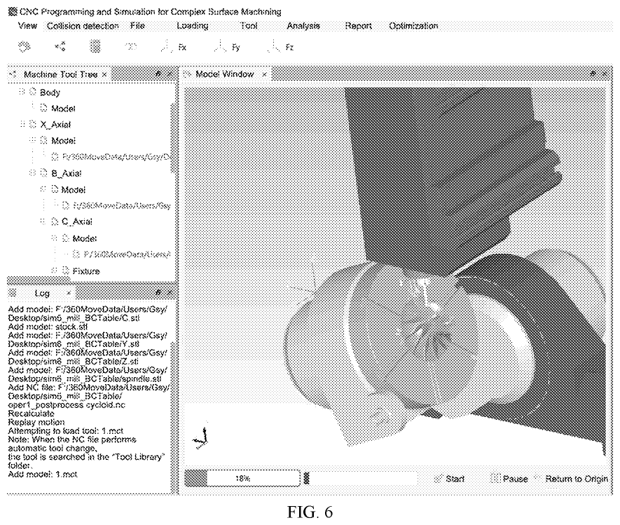

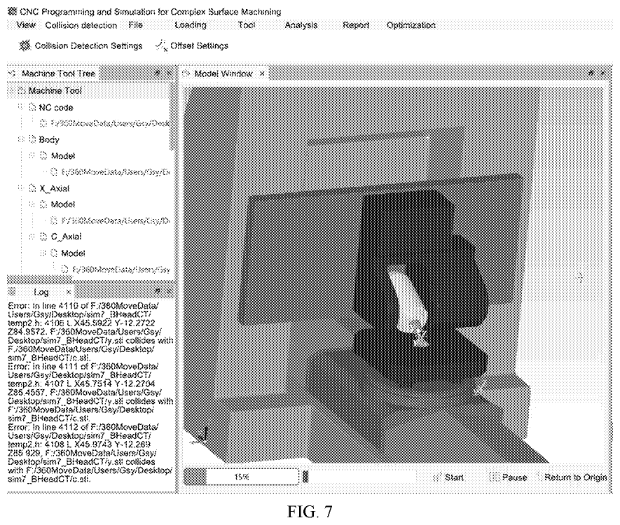

To ensure adaptability of the disclosure embodiment, the following four additional types of five-axis machine tools are evaluated:
1. A five-axis machine tool (FIG. 4) having a structure of workpiece-C rotary table-Y-axis-machine bed-X-axis-Z-axis-45° B swing head-tool.
2. A five-axis machine tool (FIG. 5) having a structure of workpiece-machine bed-Y-axis-X-axis-Z-axis-C-axis-A-axis-tool.
3. A five-axis machine tool (FIG. 6) having a structure of workpiece-C rotary table-B rotary table-X-axis-machine bed-Y-axis-Z-axis-tool, where the machine bed is omitted for ease of illustration.
4. A five-axis machine tool (FIG. 7) having a structure of workpiece-C rotary table-X-axis-machine bed-Z-axis-Y-axis-B swing head-tool.

The embodiments of the present disclosure further provide a non-transitory computer-readable storage medium. The non-transitory computer-readable storage medium stores a computer program that, when executed by a computer, causes the computer to perform functions corresponding to the machine tool tree construction module, the coordinate system transformation module, the joint parameter calculation module, the motion simulation module, and the collision detection module in the foregoing collision detection system.

The embodiments of the present disclosure further provide an electronic device, including:
one or more processors;
a memory; and
one or more programs stored in the memory and configured to be executed by the one or more processors, wherein the one or more programs include instructions that, when executed, cause the electronic device to perform functions corresponding to the machine tool tree construction module, the coordinate system transformation module, the joint parameter calculation module, the motion simulation module, and the collision detection module in the foregoing collision detection system.

In summary, compared with the prior art, the present disclosure achieves the following beneficial effects.

1. The embodiments of the present disclosure can use a single five-axis CNC machine tool collision detection system to perform motion simulation and collision detection for five-axis CNC machine tools having arbitrary structures. This avoids use of different processing schemes for five-axis CNC machine tools having different structures and avoids development of dedicated simulation software applicable only to a specific machine tool model, thereby effectively improving versatility and efficiency of motion simulation and collision detection for five-axis CNC machine tools.

2. In the embodiments of the present disclosure, a user can set offsets of nodes, such that different rotary axes, prismatic axes, tools, and workpiece offsets can be used in five-axis CNC machine tools having a same layout, thereby further improving adaptability of the technical solutions of the present disclosure.

3. The embodiments of the present disclosure support an advanced function of tool tip following, thereby enabling advanced functions of the five-axis CNC machine tool over a three-axis CNC machine tool to be covered.

4. Based on the above advantages, the embodiments of the present disclosure can extract meshes and positions of various models for collision detection, thereby achieving high detection accuracy.

It may be noted that, in the present specification, relational terms such as “first” and “second” are merely used to distinguish one entity or operation from another entity or operation, and do not necessarily require or imply any actual relationship or sequence between these entities or operations. Moreover, the terms “comprise,” “include,” or any variations thereof are intended to cover non-exclusive inclusion, such that a process, method, article, or apparatus comprising a series of elements includes not only those elements but also other elements not expressly listed or elements inherent to the process, method, article, or apparatus. Unless otherwise expressly limited, an element defined by the phrase “comprising a/an . . . ” does not exclude existence of additional identical elements in the process, method, article, or apparatus comprising the element.

The above embodiments are merely configured to illustrate the technical solutions of the present disclosure rather than limiting the present disclosure. Although the present disclosure has been described in detail with reference to the foregoing embodiments, those skilled in the art will appreciate that modifications may still be made to the technical solutions described in the foregoing embodiments, or equivalent substitutions may be made to some technical features thereof. Such modifications or substitutions do not depart from the spirit and scope of the technical solutions of embodiments of the present disclosure.

What is claimed is:

1. A system for collision detection of a five-axis computer numerical control (CNC) machine tool, comprising:
a machine tool tree construction module, configured to set inner nodes and outer nodes according to a structure of the five-axis CNC machine tool to construct a machine tool tree, and to obtain offsets of the inner nodes and the outer nodes, wherein the outer nodes correspond to three-dimensional models of components of the five-axis CNC machine tool, and the inner nodes correspond to joints of the five-axis CNC machine tool;
a coordinate system transformation module, configured to calculate, according to the machine tool tree and the offsets, homogeneous transformation matrices of joint coordinate systems, three-dimensional model coordinate systems, a tool tip point coordinate system, and a workpiece coordinate system relative to a world coordinate system {O} when the five-axis CNC machine tool is at an initial position;
a joint parameter calculation module, configured to read a numerical control program and calculate joint parameters of the five-axis CNC machine tool according to the homogeneous transformation matrices;
a motion simulation module, configured to, starting from a root node of the machine tool tree and in an order from a parent node to a child node, sequentially calculate exponential products of the joints and homogeneous transformation matrices of the three-dimensional model coordinate systems relative to the world coordinate system {O} using a recursive computation method, and to set positions of the three-dimensional models to perform motion simulation; and
a collision detection module, configured to calculate absolute coordinates of surface points on links corresponding to two joints among the joints during the motion simulation, and to perform collision detection between two sets of meshes.

2. The system according to claim 1, wherein the coordinate system transformation module configured to calculate, according to the machine tool tree and the offsets, the homogeneous transformation matrices of the joint coordinate systems, the three-dimensional model coordinate systems, the tool tip point coordinate system, and the workpiece coordinate system relative to the world coordinate system {O} when the five-axis CNC machine tool is at the initial position is configured to:
calculate, according to the machine tool tree and the offsets, homogeneous transformation matrices of the joint coordinate systems relative to the world coordinate system {O} when the five-axis CNC machine tool is at the initial position according to the following expression:
$$\{ \begin{matrix}{}^{O} {T}_{1} ( 0 ) = {I}_{4 \times 4} \\ {}^{O} {T}_{i} ( 0 ) = {}^{O} {T}_{i - 1} ( 0 ) {}^{i - 1} {T}_{i} ( i = 2 , … , n )\end{matrix} ,$$
wherein i denotes an i-th joint on a current kinematic chain, n denotes a total number of joints on the current kinematic chain, and a first joint is a machine bed joint, and ⁱ⁻¹Tᵢ denotes an offset of an i-th node; and
calculate, according to the machine tool tree and the offsets, homogeneous transformation matrices of the three-dimensional model coordinate systems, the tool tip point coordinate system {t}, and the workpiece coordinate system {w} relative to the world coordinate system {O} when the five-axis CNC machine tool is at the initial position according to the following expression:
$${}^{O} {T}_{l} ( 0 ) = {}^{O} {T}_{j} {( 0 )}^{j} {T}_{l} ,$$
wherein ^{O}Tⱼ denotes a homogeneous transformation matrix of a corresponding joint coordinate system relative to the world coordinate system {O}, and ^{j}Tₗ denotes an offset of a node or a homogeneous transformation matrix of the tool tip point coordinate system {t} or the workpiece coordinate system {w} relative to the corresponding joint coordinate system.

3. The system according to claim 1, wherein the joint parameter calculation module configured to read the numerical control program and calculate the joint parameters of the five-axis CNC machine tool according to the homogeneous transformation matrices is configured to:
(S301) calculate revolute joint parameters according to the following expression:
$${}^{w} {T}_{t} {( {θ}_{1} , {θ}_{2} , {θ}_{3} , {θ}_{4} , {θ}_{5} )}_{, 3} = {}^{O} {T}_{w}^{- 1} ( 0 ) {e}^{{m}_{1} {θ}_{1} {[}^{O} {\overline{S}}_{1} ]} {e}^{{m}_{2} {θ}_{2} {[}^{O} {\overline{S}}_{2} ]} {e}^{{m}_{3} {θ}_{3} {[}^{O} {\overline{S}}_{3} ]} {e}^{{m}_{4} {θ}_{4} {[}^{O} {\overline{S}}_{4} ]} {e}^{{m}_{5} {θ}_{5} {[}^{O} {\overline{S}}_{5} ] O} {{T}_{t} ( 0 )}_{, 3} ; \qquad ( 1 )$$
wherein θᵢ(i=1,2,3,4,5) denotes a joint parameter of an i-th joint on two kinematic chains consisting of a kinematic chain from the workpiece coordinate system {w} to a machine bed coordinate system {b} and a kinematic chain from the machine bed coordinate system {b} to the tool tip point coordinate system {t};
wherein ^{O}S̅ᵢ(i=1,2,3,4,5) denotes a motion twist under unit velocity in the world coordinate system {O} at an initial state;
wherein in a case where a corresponding joint is on a tool kinematic chain, mᵢ=1, and in a case where the corresponding joint is on a workpiece kinematic chain, mᵢ=−1;
wherein in a case where the corresponding joint is a revolute joint,
$${}^{O} \overline{{S}_{i}} = [ \begin{matrix}{}^{O} {\overline{ω}}_{i} \\ {}^{O} {\overline{p}}_{i} \times {}^{O} {\overline{ω}}_{i}\end{matrix} ] ,$$
and in a case where the corresponding joint is a prismatic joint,
$${}^{O} \overline{{S}_{i}} = [ \begin{matrix}{0}_{3 \times 1} \\ {}^{O} \overline{{v}_{i}}\end{matrix} ] , and {e}^{[ {}^{O} {\overline{S}}_{i} ] {m}_{i} {θ}_{i}} = [ \begin{matrix}{e}^{[ {}^{O} {\overline{ω}}_{i} ] {m}_{i} {θ}_{i}} & {G ( {m}_{i} {θ}_{i} )}^{O} {\overline{v}}_{i} \\ 0 & 1\end{matrix} ] ,$$
wherein 0_{3×1} denotes a column vector consisting of three zeros, ^{O}v̅ᵢ and ^{O}ω̅ᵢ each denote a unit vector in a direction of joint motion, ^{O}p̅ᵢ denotes a vector from an origin of the world coordinate system {O} to an origin of an i-th joint coordinate system,
$${e}^{[ {O}^{} {\overline{ω}}_{i} ] {m}_{i} {θ}_{i}} = I + [ {O}^{} {\overline{ω}}_{i} ] sin ( {m}_{i} {θ}_{i} ) + {[ {O}^{} {\overline{ω}}_{i} ]}^{2} ( 1 - cos ( {m}_{i} {θ}_{i} ) ) ,$$
and G(mᵢθᵢ)=mᵢθᵢI+(1−cos(mᵢθᵢ))[^{O}ω̅ᵢ]+(mᵢθᵢ−sin(mᵢθᵢ))[^{O}ω̅ᵢ]²;
wherein according to properties of homogeneous matrices and expression (1), the following expression is satisfied:
$${}^{w} {R}_{t} {( {θ}_{1} , {θ}_{2} , {θ}_{3} , {θ}_{4} , {θ}_{5} )}_{, 3} = {}^{O} {R}_{w}^{- 1} ( 0 ) {e}^{{m}_{{R}_{1}} {θ}_{{R}_{1}} [ {}^{O} {\overline{ω}}_{{R}_{1}} ]} {e}^{{m}_{{R}_{2}} {θ}_{{R}_{2}} [ {}^{O} {\overline{ω}}_{{R}_{2}} ]} {}^{O} {R}_{t} {( 0 )}_{, 3} ,$$
wherein ^{O}R_{w}⁻¹(0) denotes an inverse of a rotation matrix of the workpiece coordinate system {w} relative to the world coordinate system {O} in a case where a joint parameter is zero, Rᵢ(0)_{,3} denotes a rotation matrix of a tool coordinate system relative to the world coordinate system {O} in a case where the joint parameter is zero, and Rᵢ, i=1,2 denote an i-th revolute joint in the same order as described above;
wherein
$${e}^{- {m}_{{R}_{1}} - {θ}_{{R}_{1}} [ {}^{O} {\overline{ω}}_{{R}_{1}} ]} a = {e}^{{m}_{{R}_{2}} {θ}_{{R}_{2}} [ {}^{O} {\overline{ω}}_{{R}_{2}} ]} b = c$$
is solved using Paden-Kahan subproblem 2, wherein a=^{O}R_{w}(0)^{w}Rₜ(θ₁,θ₂,θ₃,θ₄,θ₃)_{,3}, b=^{O}Rₜ(0)_{,3}, c=α^{O}ω̅_{R}_{₁}+β^{O}ω̅_{R}_{₂}+γ(^{O}ω̅_{R}_{₁}×^{O}ω̅_{R}_{₂}), wherein
$$α = \frac{( {}^{O} {ω}_{{R}_{\text{?}}}^{T} {}^{O} {ω}_{{R}_{\text{?}}}^{T} ) {}^{O} {\overline{ω}}_{{R}_{\text{?}}}^{T} b - {}^{O} {\overline{ω}}_{{R}_{\text{?}}}^{T} a}{{( {}^{O} {\overline{ω}}_{{R}_{\text{?}}}^{T} {}^{O} {\overline{ω}}_{{R}_{\text{?}}}^{T} )}^{2} - 1}$$
$$β = \frac{( {}^{O} {\overline{ω}}_{{R}_{\text{?}}}^{T} {}^{O} {\overline{ω}}_{{R}_{\text{?}}}^{T} ) {}^{O} {\overline{ω}}_{{R}_{\text{?}}}^{T} a - {}^{O} {\overline{ω}}_{{R}_{\text{?}}}^{T} b}{{( {}^{O} {\overline{ω}}_{{R}_{\text{?}}}^{T} {}^{O} {\overline{ω}}_{{R}_{\text{?}}}^{T} )}^{2} - 1}$$
$$γ = \pm \sqrt{\frac{{‖ a ‖}^{2} - {α}^{2} - {β}^{2} - 2 αβ {}^{O} {\overline{ω}}_{{R}_{\text{?}}}^{T} {}^{O} {\overline{ω}}_{{R}_{\text{?}}}}{{‖ {}^{O} {\overline{ω}}_{{R}_{\text{?}}} \times {}^{O} {\overline{ω}}_{{R}_{\text{?}}} ‖}^{2}}}$$
$$\text{?} \text{indicates text missing or illegible when filed}$$
and
the following solutions are obtained:
$${θ}_{{R}_{1}} = \frac{- a tan 2 ( {}^{O} {\overline{ω}}_{{R}_{1}}^{T} ( u \times v ) , {u}^{T} v )}{{m}_{{R}_{1}}} ,$$
$$wherein u = a - {}^{O} {\overline{ω}}_{{R}_{1}} {}^{O} {\overline{ω}}_{{R}_{1}}^{T} a , v = c - {}^{O} {\overline{ω}}_{{R}_{1}} {}^{O} {\overline{ω}}_{{R}_{1}}^{T} c ;$$
$${θ}_{{R}_{2}} = \frac{a tan 2 ( {}^{O} {\overline{ω}}_{{R}_{2}}^{T} ( {u}^{′} \times {v}^{′} ) , {u}^{′ T} {v}^{′} )}{{m}_{{R}_{2}}} ,$$
$$wherein {u}^{′} = b - {}^{O} {\overline{ω}}_{{R}_{2}} {}^{O} {\overline{ω}}_{{R}_{2}}^{T} b , {v}^{′} = c - {}^{O} {\overline{ω}}_{{R}_{2}} {}^{O} {\overline{ω}}_{{R}_{2}}^{T} c ,$$
and wherein ^{O}ω̅_{R}_{₁} denotes a unit vector in a motion direction of a first revolute joint, and ^{O}ω̅_{R}_{₂} denotes a unit vector in a motion direction of a second revolute joint.

4. The system according to claim 3, wherein the joint parameter calculation module configured to read the numerical control program and calculate the joint parameters of the five-axis CNC machine tool according to the homogeneous transformation matrices is further configured to:
(S302) calculate prismatic joint parameters according to the following expression:
$${}^{O} {T}_{M} {( 0 )}^{M} {{T}_{t} ( {θ}_{1} , {θ}_{2} , {θ}_{3} , {θ}_{4} , {θ}_{5} )}_{, 4} = {T}_{1} {e}^{{m}_{{p}_{1}} {θ}_{{p}_{1}} {[}^{O} {\overline{S}}_{{p}_{1}} ]} {T}_{2} {e}^{{m}_{{p}_{2}} {θ}_{{p}_{2}} {[}^{O} {\overline{S}}_{{p}_{2}} ]} {T}_{3} {e}^{{m}_{{p}_{3}} {θ}_{{p}_{3}} {[}^{O} {\overline{S}}_{{p}_{3}} ]} {T}_{4} {}^{O} {T}_{t} {( 0 )}_{, 4} \qquad ( 2 )$$
wherein pᵢ, i=1,2,3 denotes an i-th prismatic joint in the same order as described above, T₁ denotes a product of homogeneous transformation matrices of revolute joints before p₁, T₂ denotes a product of homogeneous transformation matrices of revolute joints between p₁ and p₂, T₃ denotes a product of homogeneous transformation matrices of revolute joints between p₂ and p₃, and T₄ denotes a product of homogeneous transformation matrices of revolute joints after p₃;
wherein P′ denotes a displacement portion on a left-hand side of expression (2), and satisfies the following expression:
$${P}^{′} = {P}_{{T}_{1}} + {R}_{{T}_{1}} {P}_{{e}^{{m}_{{p}_{1}} {θ}_{{p}_{1}} [ {}^{O} {\overline{S}}_{{p}_{1}} ]}} + {R}_{{T}_{1}} {P}_{{T}_{2}} + {R}_{{T}_{1}} {R}_{{T}_{2}} {P}_{{e}^{{m}_{{p}_{2}} {θ}_{{p}_{2}} [ {}^{O} {\overline{S}}_{{p}_{2}} ]}} + {R}_{{T}_{1}} {R}_{{T}_{2}} {P}_{{T}_{3}} + {R}_{{T}_{1}} {R}_{{T}_{2}} {R}_{{T}_{3}} {P}_{{e}^{{m}_{{p}_{3}} {θ}_{{p}_{3}} [ {}^{O} {\overline{S}}_{{p}_{3}} ]}} + {R}_{{T}_{1}} {R}_{{T}_{2}} {R}_{{T}_{3}} {P}_{{T}_{4}} + {R}_{{T}_{1}} {R}_{{T}_{2}} {R}_{{T}_{3}} {R}_{{T}_{4}} {P}_{{O}_{{{T}_{t} ( 0 )}_{, 4}}} ,$$
which is simplified to obtain the following expression:
$$P = {R}_{{T}_{1}} {P}_{{e}^{{m}_{{p}_{1}} {θ}_{{p}_{1}} [ {}^{O} {\overline{S}}_{{p}_{1}} ]}} + {R}_{{T}_{1}} {R}_{{T}_{2}} {P}_{{e}^{{m}_{{p}_{2}} {θ}_{{p}_{2}} [ {}^{O} {\overline{S}}_{{p}_{2}} ]}} + {R}_{{T}_{1}} {R}_{{T}_{2}} {R}_{{T}_{3}} {P}_{{e}^{{m}_{{p}_{3}} {θ}_{{p}_{3}} [ {}^{O} {\overline{S}}_{{p}_{3}} ]}} ; \qquad ( 3 )$$
$$wherein P = {P}^{′} - {P}_{{T}_{1}} - {R}_{{T}_{1}} {P}_{{T}_{2}} - {R}_{{T}_{1}} {R}_{{T}_{2}} {P}_{{T}_{3}} - {R}_{{T}_{1}} {R}_{{T}_{2}} {R}_{{T}_{3}} {P}_{{T}_{4}} - {R}_{{T}_{1}} {R}_{{T}_{2}} {R}_{{T}_{3}} {R}_{{T}_{4}} {P}_{{o}_{{{T}_{t} ( 0 )}_{, 4}}} ,$$
and according to expression (3), the following expression is obtained:
$$P = {R}_{x} {P}_{{e}^{{m}_{x} {θ}_{x} [ \overline{{}^{O} {S}_{x}} ]}} + {R}_{y} {P}_{{e}^{{m}_{y} {θ}_{y} [ \overline{{}^{O} {S}_{y}} ]}} + {R}_{z} {P}_{{e}^{{m}_{z} {θ}_{z} [ \overline{{}^{O} {S}_{z}} ]}} ,$$
wherein x denotes an X-axis prismatic joint, y denotes a Y-axis prismatic joint, and z denotes a Z-axis prismatic joint, and Rₓ,R_{y},R_{z} respectively denote corresponding SO(3) components in expression (3);
wherein let
$$P = R [ \begin{matrix}{θ}_{x} \\ {θ}_{y} \\ {θ}_{z}\end{matrix} ] = [ \begin{matrix}X \\ Y \\ Z\end{matrix} ] , R = [ {m}_{x} {R}_{x} {}^{O} {v}_{x} {m}_{y} {R}_{y} {}^{O} {v}_{y} {m}_{z} {R}_{z} {}^{O} {v}_{z} ] ,$$
and u=R_{1,1}R_{2,2}R_{3,3}−R_{3,2}R_{2,3}+R_{2,1}R_{3,2}R_{1,3}−R_{1,2}R_{3,3}+R_{3,1}R_{1,2}R_{2,3}−R_{2,2}R_{1,3};
the following solutions are obtained:
$$\{ \begin{matrix}{θ}_{x} = \frac{\begin{matrix}( {R}_{2 , 2} {R}_{3 , 3} - {R}_{3 , 2} {R}_{2 , 3} ) X + ( {R}_{3 , 2} {R}_{1 , 3} - \\ {R}_{1 , 2} {R}_{3 , 3} ) Y + ( {R}_{1 , 2} {R}_{2 , 3} - {R}_{2 , 2} {R}_{1 , 3} ) Z\end{matrix}}{u {m}_{x}} \\ {θ}_{y} = \frac{\begin{matrix}( {R}_{3 , 1} {R}_{2 , 3} - {R}_{2 , 1} {R}_{3 , 3} ) X + ( {R}_{1 , 1} {R}_{3 , 3} - \\ {R}_{3 , 1} {R}_{1 , 3} ) Y + ( {R}_{2 , 1} {R}_{1 , 3} - {R}_{1 , 1} {R}_{2 , 3} ) Z\end{matrix}}{u {m}_{y}} \\ {θ}_{z} = \frac{\begin{matrix}( {R}_{2 , 1} {R}_{3 , 2} - {R}_{3 , 1} {R}_{2 , 2} ) X + ( {R}_{3 , 1} {R}_{1 , 2} - \\ {R}_{1 , 1} {R}_{3 , 2} ) Y + ( {R}_{1 , 1} {R}_{2 , 2} - {R}_{2 , 1} {R}_{1 , 2} ) Z\end{matrix}}{u {m}_{z}}\end{matrix} ,$$
thereby obtaining the prismatic joint parameters;
(S303) when a tool tip following function is turned off, joint parameters corresponding to a numerical control program Xx_{nc} Y y_{nc} Zz_{nc} Aa_{nc} Bb_{nc} Cc_{nc} are:
$${θ}_{x}^{′} = {m}_{x} {x}_{n c} + {θ}_{x} , {θ}_{y}^{′} = {m}_{y} {y}_{n c} + {θ}_{y} , {θ}_{z}^{′} = {m}_{z} {z}_{n c} + {θ}_{z} ,$$
$${θ}_{a}^{′} = {m}_{a} {a}_{n c} , {θ}_{b}^{′} = {m}_{b} {b}_{n c} , {θ}_{c}^{′} = {m}_{c} {c}_{n c} ;$$
wherein θₓ,θ_{y},θ_{z} are joint parameters, wherein
$${}^{w} {T}_{t} {( {θ}_{1} , {θ}_{2} , {θ}_{3} , {θ}_{4} , {θ}_{5} )}_{, 4} = [ \begin{matrix}0 \\ 0 \\ 0 \\ 1\end{matrix} ] ,$$
the revolute joint parameters are set to 0, and wherein mᵢ(i=x,y,z,a,b,c)=−1 in a case where the corresponding joint is on the workpiece kinematic chain and mᵢ(i=x,y,z,a,b,c)=1 in a case where the corresponding joint is on the tool kinematic chain; and
(S304) when the tool tip following function is turned on, joint parameters corresponding to the numerical control program Xx_{nc} Y y_{nc} Zz_{nc} Aa_{nc} Bb_{nc} Cc_{nc} are
$${θ}_{a}^{′} = {m}_{a} {a}_{n c} , {θ}_{b}^{′} = {m}_{b} {b}_{nc} , {θ}_{c}^{′} = {m}_{c} {c}_{n c} ;$$
$$wherein {θ}_{x}^{′} , {θ}_{y}^{′} , {θ}_{z}^{′}$$
are obtained by calculating
$${θ}_{a}^{′} , {θ}_{b}^{′} , {θ}_{c}^{′}$$
and then through step (S302), wherein at step (S302),
$${}^{w} {T}_{t} {( {θ}_{1} , {θ}_{2} , {θ}_{3} , {θ}_{4} , {θ}_{5} )}_{, 4} = [ \begin{matrix}{m}_{x} {x}_{n c} \\ {m}_{y} {y}_{n c} \\ {m}_{z} {z}_{n c} \\ 1\end{matrix} ] ,$$
and wherein mᵢ(i=x, y, z)=−1 in a case where a corresponding prismatic joint is on the workpiece kinematic chain and mᵢ(i=x, y, z)=1 in a case where the corresponding prismatic joint is on the tool kinematic chain.

5. The system according to claim 1, wherein the motion simulation module configured to, starting from the root node of the machine tool tree and in the order from the parent node to the child node, sequentially calculate exponential products of the joints and the homogeneous transformation matrices of the three-dimensional model coordinate systems relative to the world coordinate system {O} using the recursive computation method, and to set the positions of the three-dimensional models to perform the motion simulation is configured to:
calculate an exponential product of each of joints on a workpiece kinematic chain and a tool kinematic chain according to the following expression:
$$\{ \begin{matrix}{T}_{1} = {I}_{4 \times 4} \\ {T}_{i} = {T}_{i - 1} {e}^{{θ}_{i} {[}^{O} \overline{{S}_{i}} ] O} ( i = 2 , … , n )\end{matrix} ,$$
wherein i denotes an i-th joint on a current kinematic chain, n denotes a total number of joints on the current kinematic chain, and a first joint is a machine bed joint, and θᵢ denotes a joint parameter of an axis joint, wherein i=1,2,3,4,5, and for a non-axis joint, θᵢ=0; and
calculate a homogeneous transformation matrix of each three-dimensional model coordinate system of the three-dimensional model coordinate systems relative to the world coordinate system {O} according to the following expression:
$${}^{O} {T}_{m} = {T}^{O} {\overline{T}}_{m} ,$$
wherein T denotes an exponential product of a joint corresponding to the three-dimensional model that corresponds to the three-dimensional model coordinate system, and ^{O}T̅ₘ denotes a homogeneous transformation matrix of the three-dimensional model coordinate system relative to the world coordinate system {O} when the five-axis CNC machine tool is at the initial position.

6. The system according to claim 1, wherein the collision detection module configured to calculate the absolute coordinates of the surface points on the links corresponding to the two joints among the joints during the motion simulation, and to perform the collision detection between the two sets of meshes is configured to:
determine that the three-dimensional models corresponding to all child nodes of a node of the machine tool tree that corresponds to a joint constitute links of the joint;
extract meshes of the three-dimensional models corresponding to all child nodes, and construct two bounding volume hierarchies of two links using a Morton Code method;
compare the two bounding volume hierarchies during collision detection, and when the two bounding volume hierarchies do not intersect, determine that two sets of triangle meshes do not intersect; and
when the two bounding volume hierarchies intersect, perform pairwise detection of intersections of child bounding volume hierarchies or sub-meshes until intersection testing of the triangle meshes is finally performed, and when the triangle meshes intersect, confirm that a collision occurs.

7. A non-transitory computer-readable storage medium, wherein the non-transitory computer-readable storage medium stores a computer program that, when executed by a computer, causes the computer to perform functions of the machine tool tree construction module, the coordinate system transformation module, the joint parameter calculation module, the motion simulation module, and the collision detection module in the system according to claim 1.

8. An electronic device, comprising:
one or more processors;
a memory; and
one or more programs stored in the memory and configured to be executed by the one or more processors;
wherein the one or more programs, when executed by the one or more processors, cause the one or more processors to perform functions of the machine tool tree construction module, the coordinate system transformation module, the joint parameter calculation module, the motion simulation module, and the collision detection module in the system according to claim 1.
